(19) United States
(12) Patent Application Publication
(10) Pub. No.: US 2025/0041865 A1
(43) Pub. Date: Feb. 6, 2025

(54) Reaction vessel unit, method for selectively removing a liquid and for introducing a liquid containing a target substance from or into a reaction vessel of a reaction vessel unit

(71) Applicant: BlueCat Solutions GmbH, Neudrossenfeld (DE)

(72) Inventors: Frank Feist, Lebanon, NH (US); Wolfgang Mann, Neudrossenfeld (DE); Konstantin Mann, Coburg (DE)

(21) Appl. No.: 18/718,814

(22) PCT Filed: Dec. 13, 2022
(86) PCT No.: PCT/EP2022/085722

§ 371 Date: Jun. 12, 2024

(30) Foreign Application Priority Data
Dec. 13, 2021 (DE) 10 2021 006 144.6

(51) Int. Cl. B01L 3/00; G01N 1/34; G01N 15/10; G01N 15/14

(52) U.S. Cl. CPC B01L 3/5085; G01N 1/34; G01N 15/14; B01L 2300/0829; B01L 2300/161; B01L 2400/0406; B01L 2400/0409; G01N 2015/1006

(57) ABSTRACT

A reaction vessel unit having at least one reaction vessel which has a receiving chamber for receiving a liquid, wherein the receiving chamber has a retention area which has such a surface texture and/or shape that due to an adhesive force between the liquid and the retention area and a cohesion within the liquid, the retention area exerts an increased retention effect on the liquid with respect to the surrounding area, so that a predetermined small amount of liquid is retained at or in the retention area when the liquid is removed from the receiving chamber by centrifuging. Further disclosed is a method for selectively removing a liquid from a reaction vessel of the reaction vessel unit by centrifugation and a method for introducing a liquid containing a target substance into a reaction vessel with a guiding system by centrifugation or magnetic or electrostatic interaction.

The present invention relates to a reaction vessel unit with at least one reaction vessel, a method for selectively removing a liquid from a reaction vessel of a reaction vessel unit and a method for introducing a liquid containing a target substance into a reaction vessel of a reaction vessel unit.

It is a well-known phenomenon in laboratory work that small volumes remain or are retained when reaction vessels are emptied. Pipetting devices and pipetting robots are familiar with the problem of the so-called residual volume. There is often a desire to precisely determine the residual volume. For example, if there are cells in microtiter plates, and more recently also organoids or spheroids as cell composites, the phenomenon of residual volume poses a particular challenge when changing the culture medium. In these cases, the cellular structure should usually remain in the reaction vessel, while the supernatant is removed and replaced with fresh medium, for example.

For series tests such as flow cytometry, it is necessary to purify the cells suspended in a nutrient fluid before they are tested so that metabolic products, dyes, markers or the like that are present or have accumulated in the nutrient fluid do not interfere with the test. In flow cytometry, fluorescently labelled molecules in suspension format are subjected to multi-parametric analysis through a fluidic system in which the cells pass through a laser beam and qualitative/quantitative data is obtained from the detection of light scatter and excitation bands. Further information can be found, for example, in Fortis Life Sciences, “Flow Cytometry Protocols for Extracellular & Intracellular Targets”, available for download on the filing date at https://www.fortislife.com/products/documents/flow-cytometry-protocols-for-extracellular-intracellular-targets/appnote002. For the purpose of purification, it is usual to pellet the cells by centrifugation at, for example, 300 g for a period of, for example, 5 minutes. Pelletisation represents a high stress factor for the cells. This can lead to undesirable reactions or activations, such as a change in gene expression, which can be detrimental or falsify subsequent measurements.

EP 3633022 A1 discloses the structure of an intermediate part in a microtiter plate that serves as a mechanical barrier for an organoid located at the bottom of the plate. This makes it possible to remove the culture medium using a pipette without the risk of removing the organoid, i.e. aspirating it.

US 2008/0003670 A1 describes a two-sided microtiter plate with cylindrical wells that can retain fluid due to surface tension, capillary action or suitable treatment, coating or texturing of the walls.

US 2011/0278304 A1 shows suspension vessels in microtiter plates that can serve as a natural barrier.

U.S. Pat. No. 8,602,958 B1 discloses a microtiter plate, during centrifugation of which the outwardly directed reaction vessels release their liquid and the reaction vessels are emptied accordingly.

US 2021/138485 A1 and U.S. Pat. No. 11,117,142 B2 disclose centrifuging devices for cleaning a reaction vessel unit. With these centrifuging devices, the reaction vessels are arranged with their openings pointing away from the rotation axis, so that the liquid contained in the reaction vessels is thrown out during centrifuging. It has been shown that the liquid can be removed from the reaction vessels without leaving any residue and a high degree of purity can be achieved. Reaction vessels purified in this way can be reused for biological reactions in which a single molecule, in particular a DNA or RNA strand, can represent an intolerable contamination. The centrifuging of liquid from the reaction vessels by centrifuging is also referred to below as “washing by centrifuging”, wherein such a washing process can be carried out with or without the addition of a washing solution.

One task of the invention is to create a reaction vessel unit with at least one reaction vessel which enables reliable separation of two volumes contained in the reaction vessel and also enables a defined residual volume to remain in the reaction vessel when the reaction vessel is washed by centrifuging.

A further object of the invention is to provide a method for removing a liquid from a reaction vessel of a reaction vessel unit which is selective in the sense that a defined volume of fluid remains in the reaction vessel during washing by centrifuging.

A further object of the invention is to provide a method for introducing a liquid containing a target substance into a reaction vessel of a reaction vessel unit, which enables a defined volume of fluid containing at least the target substance to remain in the reaction vessel when the reaction vessel unit is washed by Centrifuging.

A further task of the invention is to provide a process for purifying a target substance, in particular cells, cell clusters, cell aggregates or organisms, distributed or suspended in a liquid, which is efficient, inexpensive and fast and in which the target substance is treated gently, in particular cells or organisms are not activated.

A further task of the invention is to provide a method for carrying out a test on a target substance, in particular cells, cell clusters, cell aggregates or organisms, distributed or suspended in a liquid, in which the target substance is treated gently, which is efficient, inexpensive and fast and in which the target substance is treated gently, in particular cells, cell clusters, cell aggregates or organisms are not activated.

One or more of the tasks of the invention are solved at least in partial aspects by the features of the independent claims. Preferred embodiments and advantageous further embodiments are indicated in the subclaims.

One aspect of the invention relates to a reaction vessel unit having at least one reaction vessel which has a receiving chamber for receiving a liquid. According to the invention, the receiving chamber has a retention area which has a surface texture and/or shape such that, due to an adhesive force between the liquid and the retention area and a cohesion within the liquid, the retention area exerts an increased retention effect on the liquid compared to the surrounding area, so that when the liquid is removed from the receiving chamber by centrifuging, a predetermined amount of liquid, in particular a small amount compared to the receiving chamber, is retained at or in the retention area.

For the purposes of the invention, a reaction vessel is understood to be a container that can be used in a laboratory environment and in which a chemical reaction or a biological or microbiological process takes place or can be carried out. A reaction vessel unit may comprise a single reaction vessel or combine several reaction vessels in a fixed arrangement. Liquid can be any non-gaseous fluid, wherein this can also include gelatinous or gel-like fluids. A small amount is particularly small in comparison with the receiving chamber. Since the retention area is provided which has a surface texture and/or shape such that, due to an adhesive force between the liquid and the retention area and a cohesion within the liquid, the retention area exerts an increased retaining effect on the liquid with respect to the surrounding area, so that a predetermined small amount of liquid can be retained at or in the retention area when the liquid is removed from the receiving chamber, a precisely defined residual volume can also be retained at or in the retention area when the reaction vessel is emptied. The liquid and the retention area can be considered as a system with regard to the retention effect, i.e. the properties of the liquid (for example density, surface tension, polarity or non-polarity) and the properties of the retention area (for example shape, roughness, chemical nature, critical angle with the liquid) interact in the formation of the adhesive and cohesive forces to form the retention effect. This means that the retention area can be specifically adapted to the fluid used and the desired application. Since the limit value for an acceleration acting away from the retention area, below which the holding effect predominates, can be determined for a specific system of retention area and liquid, the invention is particularly suitable for use with a centrifuging device for emptying the reaction vessel while retaining the residual volume in or at the retention area by setting the speed of the centrifuging device to a value which is safely below the limit value. However, the invention is also suitable for other manual, mechanical or partially mechanical methods for removing the liquid in the receiving chamber, such as by means of a pipetting device or by simply inverting the reaction vessel unit by hand or in a tilting device. Depending on the system, gravitational acceleration may be sufficient to empty the receiving chamber, or controlled interception or impact on a surface to generate a defined acceleration below the limit value may support the emptying of the receiving chamber.

In embodiments, the receiving chamber may be bounded by a circumferential side wall and a bottom wall and the retention area may be formed in or on the bottom wall of the receiving chamber. The side wall can have a single side wall with a circular or oval or elliptical or otherwise curved cross-section or several side walls forming a polygonal, for example square or rectangular or diamond-shaped or hexagonal cross-section with sharp or rounded edges, wherein rounded edges can facilitate emptying of the receiving chamber. The bottom wall can be flat or conical or U-shaped with sharp or rounded edges to the side wall, wherein rounded edges can make it easier to empty the receiving chamber.

In embodiments, the retention area may have a capillary cavity that opens into the receiving chamber, wherein the walls of the capillary cavity are so closely spaced that a liquid is held in the capillary cavity by capillary action. In a capillary cavity, there is a large surface area between the liquid and the capillary cavity, which leads to a correspondingly high adhesive force due to the interfacial tension.

The cohesion within the liquid due to the surface tension also holds the liquid molecules together so tightly that they are not carried away when the rest of the receiving chamber is emptied. The capillary effect therefore results from the specific adhesion and cohesion forces. In particular, when the liquid is ejected, the volume of liquid in the receiving chamber above the capillary cavity will separate from the volume of liquid in the capillary cavity and atmosphere will flow into the receiving chamber, so that an interface forms at the opening of the capillary cavity and the surface tension at this interface makes a pronounced contribution to the holding effect. Since the limit value for an acceleration acting away from the opening of the capillary cavity, below which the capillary effect predominates, can be determined for a specific system of capillary cavity and liquid, the invention is particularly well suited for the use of a centrifuging device for emptying the reaction vessel while maintaining the residual volume in the capillary cavity by setting the speed of the centrifuging device to a value which is safely below the limit value. The capillary cavity can be formed as a recess in a bottom or side wall of the receiving chamber. The opening of the capillary cavity may be formed in the centre of the bottom wall or off-centre with sharp or rounded edges to the bottom wall of the receiving chamber, wherein sharp edges may facilitate retention of the liquid in the capillary cavity by capillary action. In alternative embodiments, the capillary cavity can also open into a side wall of the receiving chamber, which allows a higher speed when emptying the receiving chamber. However, handling of the liquid volumes may be easier if the capillary cavity opens into the bottom wall of the receiving chamber.

Preferably, only a single capillary cavity is present, which simplifies access for pipetting or rinsing and also ensures that a certain amount of a target substance in the liquid can be reliably assigned to a specific capillary volume. For other applications, however, there can also be several capillary cavities that can be rinsed out individually in order to remove a target substance collected in them, such as cells.

Furthermore, it is preferred if the capillary cavity is essentially free of dividing walls, so that a content of the capillary cavity can be completely removed or rinsed out of the capillary cavity by introducing a fluid jet. Dividing walls or other protruding structures are lateral barriers; these can form dead zones in which a target substance can remain when the capillary cavity is rinsed out. Such dead zones are a hindrance when emptying the capillary cavity and should therefore be avoided. To support the rinsing process, however, a conical or pyramid-like central elevation can be formed at the bottom of the capillary cavity, which can act as a jet divider or jet deflector for a fluid jet, but does not form a lateral barrier.

In embodiments, the capillary cavity may have a rectangular, round or oval cross-section. A wall distance between opposing side walls or wall sections of the wall of the capillary cavity may be dimensioned to retain liquid by capillary action between the opposing side walls or wall sections of the wall of the capillary cavity. Depending on the liquid and the nature of the wall, the wall distance can be, for example, at most 2.0 mm or at most 1.8 mm or at most 1.6 mm or at most 1.4 mm or at most 1.2 mm or at most 1.0 mm or at most 0.8 mm. Furthermore, the wall distance can be at least 0.1 mm or 0.3 mm or 0.5 mm or 0.8 mm, for example. The wall distance can be advantageously dimensioned to optimise the capillary effect with respect to a distance between side walls of the receiving chamber if the wall distance is at most 30% or at most 25% or at most 20% or at most 15% or at most 10% or at most 5% of the wall distance between the side walls of the receiving chamber.

With regard to the capillary effect, it is also advantageous if the capillary cavity has a depth that is at least 0.5 times or at least 1 time or at least 1.5 times or at least 2 times a wall distance between opposing side walls or wall sections of the capillary cavity.

To form an effective capillary effect, it is advantageous if the side walls of the capillary cavity are vertical or essentially vertical with a deviation of at most 5° or at most 3° or at most 2° or at most 1° or at most 0.5° from the vertical.

In embodiments, a bottom wall of the receiving chamber can slope conically towards an opening of the capillary cavity or be U-shaped. As a result, the bottom wall of the receiving chamber can form an introduction funnel for a target substance that is to enter the capillary cavity. This avoids obstacles that act perpendicular to the centrifugal force, particularly during Centrifuging, and the target material, such as cells, can slide along the bottom wall into the capillary cavity. Such a shape also makes it easier to remove the liquid from the receiving chamber and tear off the volume in the capillary cavity. The steeper the insertion funnel, the more pronounced this favourable effect becomes. This must be harmonised with other effects. The steeper the bottom wall, the larger its surface area. This also increases the likelihood of the target substance, such as cells, cell clusters, cell aggregates or organisms, adhering to the reaction vessel. Also, as the slope increases, the volume of the receiving chamber available as a reaction volume decreases. Depending on the application, an ideal tilt angle must be determined between these effects, which may depend on parameters such as the viscosity of the liquid or the target substance, the surface properties of the bottom wall, the adhesion potential of the target substance or similar. For example, the inclination angle of the bottom wall can be at least 5° or at least 15° or at least 25° or at least 35° or at least 45° and/or at most 75° or at most 65° or at most 55° or at most 45°. The angle of inclination is measured relative to the plane of the opening of the capillary cavity. If the retention area is not a capillary cavity, the inclination angle is measured to a tangential plane of a wall region in which the retention area is formed.

To increase the capillary effect of the capillary cavity in relation to the receiving chamber, a side wall of the receiving chamber can also be designed to widen towards the opening with a deviation of at least 2° or at least 3° or at least 5° or at least 10° from the vertical.

In embodiments, the capillary cavity may have two opposing side walls, the distance between which is dimensioned to exert the capillary effect, and a bottom wall extending between the side walls, wherein the bottom wall is continuously curved or wherein two end walls extending between the side walls are also provided, which rise from the bottom wall to an edge of the capillary cavity at an angle, in particular at a flat angle, or concavely curved. Such a design makes it possible to easily flush out the fluid volume held in the capillary cavity by capillary action by means of a jet of liquid or compressed air along the bottom wall or one of the sloping end walls.

In embodiments, the walls of the capillary cavity can have a widening towards the opening of the capillary cavity. The widening enables the volume removed from the cavity to be controlled via the centrifugal force during centrifuging, as a balance of forces between centrifugal force and holding force depends on the distance between the walls and the angle of spread between the walls. The expansion can be conical/wedge-shaped/funnel-shaped and in particular straight or curved in a vertical section. A similar effect can be achieved if the walls of the capillary cavity have a coating with a decreasing hydrophilic or lipophilic effect towards the opening of the capillary cavity. In this case, the balance of forces between centrifugal force and holding force depends on the wall distance and the hydrophilic/lipophilic effect, so that it is also possible to control the volume removed from the cavity via the centrifugal force during centrifuging. An opening angle at the opening is preferably no more than 10° or no more than 5° or no more than 2° or no more than 1° or no more than 0.5°. The two variants of widening and decreasing hydrophilic/lipophilic effect can also be used in combination.

In embodiments, the reaction vessel unit may comprise a plurality of reaction vessels and the capillary cavities may be increasingly angled away from the centre from a line, which is in particular a centre line dividing the reaction vessel unit or the arrangement of the reaction vessels into two halves, relative to a perpendicular on a plane in which the reaction vessels are arranged. If the reaction vessel unit with capillary cavities arranged parallel to each other is centrifuged in a centrifuge, the centrifugal forces also increasingly act against the side walls of the cavities from the centre line towards the edge of the plate, because the angle to the radius from the rotation axis becomes larger. This reduces the expulsion effect. This can be compensated for by adjusting the alignment of the cavities as described above.

In embodiments, the retention area can have a surface structure that increases an adhesive effect on the liquid and a size such that a cohesion of the molecules is formed due to the cohesion within the liquid, so that a predetermined amount of the liquid is held at or in the retention area. In principle, such a retention area can also be formed on a flat surface, i.e. it is independent of capillary cavities, but can also be combined with them. The retention area should not be too large, as a droplet covering the entire retention area should form on the retention area due to cohesion (surface tension), so that a defined amount of liquid is retained. If the retention area is too large, then the droplet extending over the retention area due to cohesion is too large and heavy, so that it cannot be retained by the cohesive and adhesive forces. This results in only part of the retention area being held back with one or more small droplets whose volume is not defined. This is to be avoided. The retention area with such a surface structure can also be shaped like a trough. The more pronounced the trough, the better the ratio between the adhesion and the weight of the droplet, so that the droplet is retained.

In embodiments for aqueous solutions, the retention area may have a hydrophilic coating to improve the holding effect. In further embodiments, the receiving chamber may have a hydrophobic coating to facilitate emptying of the receiving chamber. A combination of both measures can be particularly effective, whereby the hydrophobic coating of the receiving chamber can be complementary to the hydrophilic coating of the retention area. For handling non-polar solutions, such as greasy and oily solutions, the capillary cavity may have a lipophilic coating and/or the receiving chamber may have a lipophobic coating, which may be complementary. A retention area can also be defined solely by the chemical nature of the surface in comparison with the surrounding area (hydrophilic/hydrophobic, lipophilic/lipophobic, rough/smooth, etc.), even independently of shape or capillarity. This makes it possible to achieve the same effect, for example by means of a two-dimensional spot on the flat base of a plate, namely to retain a defined volume for the subsequent reaction.

One example of reaction vessels within the meaning of the invention are microvessels, which are often combined in particular in the form of microtiter plates (MTP). The individual reaction vessels of a microtiter plate are also referred to as wells, which are usually arranged in a predetermined grid of rows and columns, which specifies a staggering in number and thus determines the possible filling volume. Cells are grown individually or in cell clusters in such microtiter plates in connection with cell-based assays. As described at the beginning, the cellular structure in the reaction vessel should generally remain undamaged when the microtiter plates are washed, while the supernatant is removed and replaced with fresh medium, for example. This can be particularly well achieved with the reaction vessel unit according to the invention by providing a microtiter plate in which a retention area according to the invention is formed in the bottom of each well.

It is particularly advantageous if all reaction vessels have an opening on the top of the microtiter plate. This makes it easy to fill and empty the receiving chamber.

The reaction vessel unit can advantageously be made of plastic such as polystyrene (PS), polypropylene (PP), polyolefin carbonate (POC), cyclo-olefin copolymers (COC) or polyvinyl chloride (PVC). This enables particularly simple, dimensionally accurate production using known manufacturing processes such as injection moulding, injection blow moulding, thermoforming or similar in combination with properties that enable optical analysis of the cavity or capillary. However, other materials are also possible, in particular glass. The use of photosensitive glasses or glass ceramics is known, for example, for the manufacture of picotiter plates.

In embodiments, the reaction vessel unit may comprise a plurality of reaction vessels and the retention effects of the retention areas of at least two reaction vessels may be different. The differences may preferably be such that the retention effect increases from a line, which is in particular a centre line dividing the reaction vessel unit or the arrangement of the reaction vessels into two halves, so that a retention force of the retention area remains constant or approximately constant across the reaction vessels when the reaction vessel unit is rotated about an axis which is parallel to the centre line and whose radius through the centre line is perpendicular to a plane in which the reaction vessels are arranged. When the reaction vessel unit (e.g. microtiter plate) is centrifuged in a centrifuge, the centrifugal forces increase from the centre line towards the edge of the plate because the distance from the rotation axis increases. This can be compensated for by adjusting the holding effect of the retention areas. For example, the wall spacing of a capillary cavity can become narrower towards the edge of the plate and/or the capillary cavities can be increasingly angled towards the centre and/or the hydrophilic/lipophilic effects of a coating can increase. Apart from this special design, variable holding effects can also be advantageous for different separation volumes or special test arrangements. For example, experimental arrangements are conceivable in which the volume is to be removed from the retention area for only some of the reaction vessels in order to realise a time series in a single plate.

Similarly, a concentration series can be realised by repeatedly holding a defined volume of a target liquid in the retention area while removing the residual volume in the receiving chamber, then adding (dispensing) a defined volume of a dilution liquid into the receiving chamber and emptying the receiving chamber after the target liquid has mixed with the dilution liquid. The defined volume of the now diluted target liquid then remains in the retention area. If, for example, the retention area has a volume of 1% compared to the receiving chamber, then dispensing results in a dilution of the target liquid initially in the retention area of 1:100 in the first step. If the receiving chamber is emptied while retaining the defined volume of the now diluted target liquid in the retention area, a dilution of 1:100×1:100 (=104) is achieved after repeating the process. If, for example, the procedure is applied differently line by line in a microtiter plate, this results in a concentration series of 1:102, 1:104, 1:106, etc. The method is particularly advantageous when a concentration series is displayed in a microtiter plate without the use of pipetting tips or other consumables, but simply by repeatedly evacuating the receiving chamber. The dilution can also be set very precisely due to the defined volumes, in particular the retention area, so that lower requirements can be placed on dispensing accuracy when dispensing the liquids.

A wide range of variants are conceivable for the practical realisation of mixing. For example, the dispensing process can be carried out in such a way that the target liquid mixes directly with the dilution liquid during dispensing, for example by combining dispensing with rinsing the retention area with the dilution liquid. Alternatively, the target liquid in the retention area can be brought into the receiving chamber with the dilution liquid by centrifugation so that the two liquids mix in the receiving chamber and, if necessary, can then be centrifuged with reverse orientation in order to reliably fill the retention area with the diluted target liquid again. The reverse case is also conceivable, namely that the dilution liquid is forced into the retention area by centrifugation. These mixing considerations are particularly relevant if the retention area is a cavity, especially a capillary cavity. Mixing is particularly easy if the retention area is determined solely or primarily by the structure or nature of the wall surface, as mixing can then be brought about by shaking or stirring or the introduction of a gas or even by the dispensing process alone.

In embodiments, a collecting device may be provided which is arranged opposite an opening of the receiving chamber or openings of the receiving chambers of the at least one reaction vessel and is designed to catch liquid escaping or expelled from the receiving chamber or receiving chambers. The collecting device may have one or more compartments, preferably in the form of a microtiter plate, wherein an opening of the compartment or openings of the compartments of the collecting device face the opening of the receiving chamber or the openings of the receiving chambers of the at least one reaction vessel. The number of compartments of the collecting device may be equal to, greater than or less than a number of the reaction vessels. For example, a second plate can be mounted on the first plate (the reaction vessel unit) as a collecting device and the supernatant can be collected from the second plate. The collected fluid can be reused, which can save a considerable amount of money on the fluids used, which are often expensive. The collecting device can be compartmentalised like the reaction vessel unit itself. Thus, for example, if the reaction vessel unit has a microtiter plate with 96 or 384 or another number of reaction vessels, the collecting device can also be designed as a microtiter plate with 96 or 384 or the other number of compartments. The collecting device can also have more or fewer compartments than reaction vessels are provided. For example, the collecting device can also be designed as a simple dish. The supernatants are then combined and an aliquot of them can be analysed, e.g. by NGS (next generation sequencing). The collecting plate can also have a number of compartments that deviates upwards or downwards from the number of reaction vessels of the reaction vessel unit.

Another aspect of the invention is a method for selectively removing a liquid from a reaction vessel of a reaction vessel unit. The liquid is contained in a reaction vessel unit as described above, and the method comprises the steps of:
Centrifuging the reaction vessel unit with the opening of the receiving chamber pointing radially away from a centrifuging axis at a speed which is lower than a limit speed at which the holding effect of the retention area is just overcome, so that a partial volume of the liquid located in or at the retention area remains there and the remaining liquid located in the receiving chamber is removed.

For this purpose, the reaction vessel unit can, for example, be arranged in a centrifuging device in a position in which the openings of all reaction vessel units point away from the centrifuging axis. The centrifuging device can then be controlled with a time-speed profile that is suitable for centrifuging out the liquid in the receiving chamber, while the liquid in or on the retention area, for example in the capillary cavity, remains there. This process is suitable both for emptying reaction vessels of nutrient or reaction liquid while retaining a target substance, such as an arrangement of cells, and for separating any volume of liquid. The method also avoids the use of special devices inside the centrifugation device, such as magnetic devices capable of holding a substance mixed with magnetic beads or the like at the bottom of the reaction vessel during centrifugation. Although this is possible in principle, it requires a higher level of technical equipment with structural changes to the centrifuging device and the movement of additional mass within the centrifuging device, as such a magnetic device must of course rotate with the reaction vessel unit.

In embodiments, it may be provided that the remaining liquid is collected in a collecting device, in particular as described above. This allows the removed residual volume to be used for other purposes, which can help to reduce costs and save resources.

Another aspect of the invention is a method for introducing a liquid containing a target substance into a reaction vessel of a reaction vessel unit, comprising the steps of:
using a reaction vessel unit as described above to contain the liquid; and
guiding the target material to the retention area by means of a guiding system, wherein the guiding system comprises
   a centrifuging device and an arrangement of the reaction vessel unit with the retention area located radially outside or substantially outside with respect to a centrifuging axis in relation to the rest of the receiving chamber, or
   a magnetic auxiliary material or a magnetic property of the target material and a magnetic device which is arranged to interact with the magnetic auxiliary material or the magnetic property, or
   an electrostatically charged auxiliary material or an electrostatic property of the target material and an electrode device which is arranged to interact with the electrostatically charged auxiliary magnetic material or the electrostatic property.

The target substance can be any substance, including chemical and biological substances, which is a component of a liquid solution and is to be specifically separated from a large part of the liquid solution. In particular, the target substance is a substance whose reaction is to be initiated or observed in the reaction vessel. In the context of the invention, a guidance system is a system which is designed to move the target substance in a desired direction, in particular towards the retention area, for example into the capillary cavity. The guiding system can react to the target substance itself and/or a matrix in which the target substance is embedded in order to form a target substance system, or to auxiliary substances contained therein.

Centrifugation is particularly suitable for target substances or target substance systems that have a higher density than the liquid. If the retention area is a capillary cavity, the process can be carried out in such a way that the opening of the capillary cavity points radially to the centrifugation axis. This means that the centrifugal acceleration acting towards the opening of the capillary cavity reliably guides the liquid towards the opening of the capillary cavity and presses it into the capillary cavity.

Magnetic auxiliary materials can be magnetic beads, for example. Electrostatically charged auxiliary materials can be any charge carriers. Certain target substances, such as DNA molecules, can be electrically charged so that they can be attracted to an electrode device. The electrode device can be provided in the reaction vessel unit, in the individual reaction vessel or externally.

Subsequent removal of the liquid in the receiving chamber by the process described above can then also reliably separate the target substance or target substance system from the remaining liquid. In particular, this can be achieved by centrifuging the reaction vessel unit with the retention area located radially inwards or essentially inwards with respect to the centrifuging axis in relation to the rest of the receiving chamber at a speed which is lower than a limit speed at which the holding effect of the retention area is just overcome, so that a partial volume of the liquid containing the target substance which is passed into or to the retention area remains there and the remaining liquid located in the receiving chamber is removed.

Here too, the remaining liquid can be collected in a collection device, in particular as described above. This enables, for example, an aliquot of an expensive reagent to be brought into or to the retention area, for example into the capillary cavity, the receiving chamber to be emptied by centrifuging and the remainder of the reagent to be collected and used for further aliquoting. For this purpose, the collecting device, such as a catcher plate, is positioned “upside down” opposite the openings of the receiving chambers of the reaction vessels before Centrifuging.

Another aspect of the invention is a method for purifying a target substance dispersed in a liquid, such as cells, cell clusters, cell aggregates or organisms, in a reaction vessel of a reaction vessel unit, wherein the liquid is in a reaction vessel unit as described above, comprising the steps of:
Collecting the target substance in the retention area, in particular by centrifuging with an arrangement of the reaction vessel unit such that the retention area is located radially outside or substantially outside with respect to a centrifuging axis in relation to the rest of the receiving chamber;
Removing the liquid from the receiving chamber by centrifuging the reaction vessel unit with the opening of the receiving chamber pointing radially away from a centrifuging axis at a speed which is lower than a limit speed at which the retaining effect of the retention area is just overcome, so that a partial volume of the liquid located in or on the retention area remains there and the remaining liquid located in the receiving chamber is removed;
introducing a further liquid into the receiving chamber, in particular by dispensing or pipetting; and
Mixing the target substance with the other liquid in the receiving chamber.

With such a purification process, pelletisation with the associated contamination can be avoided, as sufficient purification of interfering components can be achieved by collecting the target material in the capillary cavity and exchanging the liquid.

In the method of this aspect, the mixing may comprise at least one of the following:
Leave to stand for a predetermined time,
Shaking the reaction vessel unit,
Introducing the further liquid into the receiving chamber by dispensing or pipetting in such a way that the target substance is washed off or flushed out of the retention area,
Pipetting the target substance out of the retention area and pipetting it back into the other liquid introduced outside the retention area.

In an exemplary embodiment of the method, the receiving chamber may have a volume of about 200 to 400 μl, wherein the retention area is a capillary cavity at the bottom of the receiving chamber and has a volume of about 5 μl, and wherein the collection of the target substance is carried out by Centrifuging with at least 2 g or at least 5 g or at least 10 g or at least 20 g and/or at most 1000 g or at most 500 g or at most 200 g or at most 100 g or at most 50 g or at most 40 g or at most 30 g or at most 20 g for a time of at least 1 s or at least 2 s or at least 5 s or at least 10 s or at least 10 s or at least 30 s or at least 60 s or at least 90 s or at least 2 minutes or at least 5 minutes and/or for at most 60 minutes or at most 30 minutes or at most 20 minutes or at most 15 minutes or at most 10 minutes or at most 5 minutes or at most 2 minutes or at most 1 minute or at most 30 s or at most 20 s or at most 10 s or at most 5 s or at most 2 s. It is understood that impossible time ranges in which the maximum duration is less than the minimum duration are excluded. It would be conceivable, for example, to work in high-throughput applications with very high centrifugal acceleration (e.g. 1000 g) but only with a very short exposure time (e.g. 1 sec). This results in very fast and reliable collection or concentration of the target substance in the capillary cavity. Very narrow limits must be observed with regard to the exposure time in order to avoid clumping or other impairment of the target substance. Conversely, for applications with very sensitive cells, centrifuging can be carried out with very low centrifugal acceleration, e.g. 2 g, but for a very long time (e.g. 1 h). The limits for the exposure time can be defined more broadly here. In principle, the product of the exposure time and the centrifugal acceleration should not be greater than 72,000 gs or 20,000 gs and especially 1000 gs.

The volume of the receiving region of around 200 to 400 μl is typical for a 96-microtiter plate format reaction vessel unit. It can be seen that the load can be more than an order of magnitude lower than when pelleting with approx. 300 g, which significantly reduces the stress on cells or organisms. For reaction vessel units with smaller working volumes of the receiving chambers (e.g. 384 format, 1536 format), the dimensions of the capillary cavity can change accordingly, so the g-forces can be higher. In reaction vessel units with larger working volumes of the receiving chambers (e.g. 48 format), the dimensions of the capillary cavity may change accordingly, and the g-forces may be lower.

In this process, the removed liquid can also be collected in a collecting device as described above.

Another aspect of the invention is a method for carrying out a test on a target substance distributed or suspended in a liquid, such as cells, cell clusters, cell aggregates or organisms in a reaction vessel of a reaction vessel unit. The liquid is located in a reaction vessel unit as described above. The method comprises the following steps:
Purification of the target substance according to the process described above;
withdrawing a predetermined amount of the liquid in the reaction vessel with the target substance dispersed or suspended therein; and
feeding the target substance contained in the predetermined amount to a test device such as a flow cytometry device.

This method makes it possible to carry out a test with the advantages of the purification process described above. Because the cells or organisms are protected, they do not react or react only slightly, which significantly reduces the influence of the process itself on the measurement and makes the measurements much more reliable and reproducible. Of course, all other test methods on a target substance distributed or suspended in a liquid, in which the target substance may contain impurities or undesirable accompanying or auxiliary substances, can benefit from the novel method.

Selected embodiments of the present invention are described in detail below with reference to the accompanying drawings. It shows/they show:

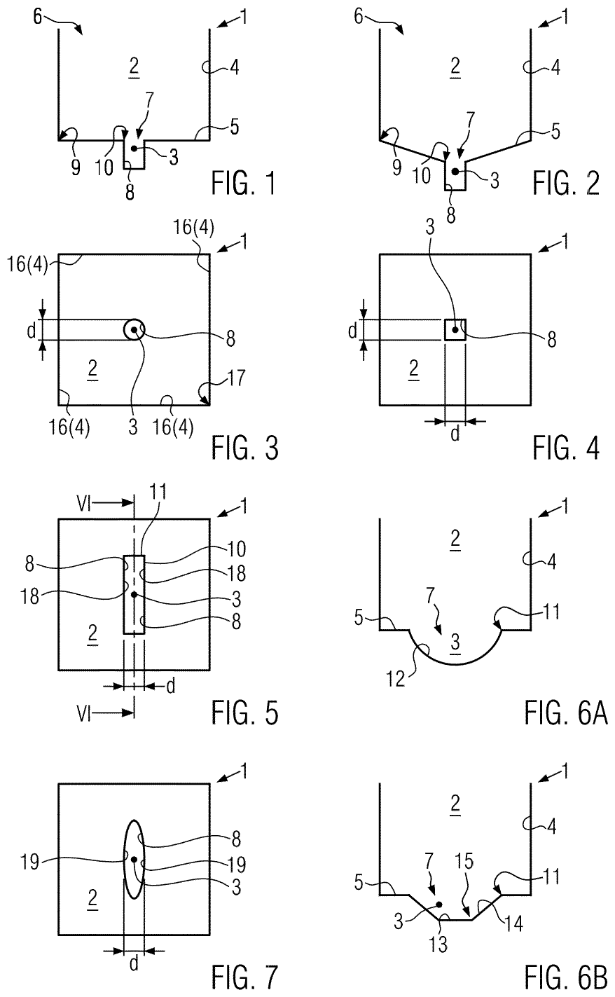

FIG. 1 is a sectional side view of a reaction vessel of a reaction vessel unit according to an embodiment of the invention;

FIG. 2 is a sectional side view of a reaction vessel of a reaction vessel unit according to an embodiment of the invention;

FIG. 3 is a top view of a reaction vessel of a reaction vessel unit according to an embodiment of the invention;

FIG. 4 is a top view of a reaction vessel of a reaction vessel unit according to an embodiment of the invention;

FIG. 5 is a top view of a reaction vessel of a reaction vessel unit according to an embodiment of the invention;

FIG. 6A shows the reaction vessel of FIG. 5 in a side view cut along a line VI-VI;

FIG. 6B shows the reaction vessel of FIG. 5 in a modified version in a side view cut along line VI-VI;

FIG. 7 is a top view of a reaction vessel of a reaction vessel unit according to an embodiment of the invention;

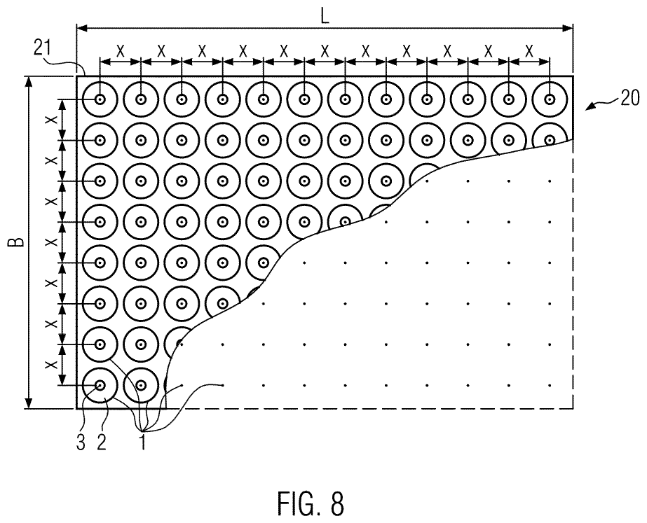

FIG. 8 is a top view of a reaction vessel unit in the form of a microtiter plate according to an embodiment of the invention;

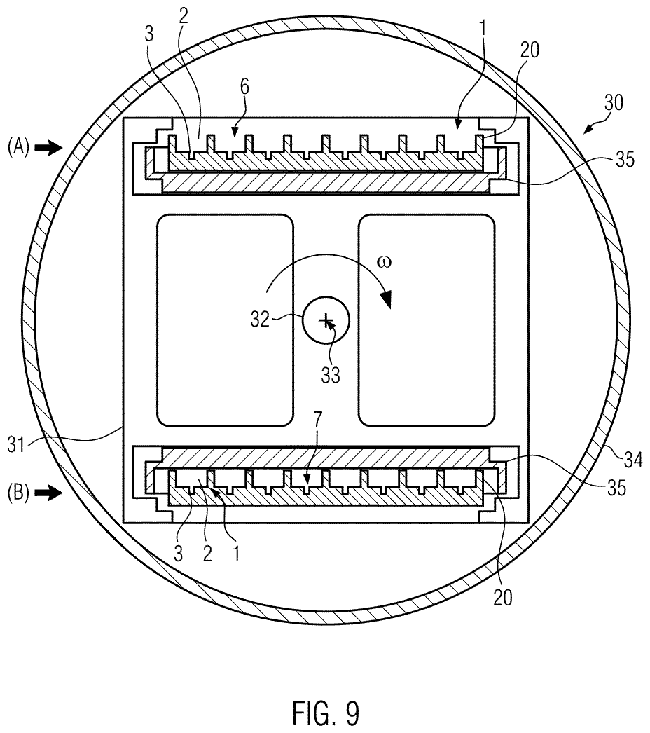

FIG. 9 a centrifuging device with two reaction vessel units as in FIG. 8 in a partially sectioned side view to illustrate processes according to embodiments of the invention;

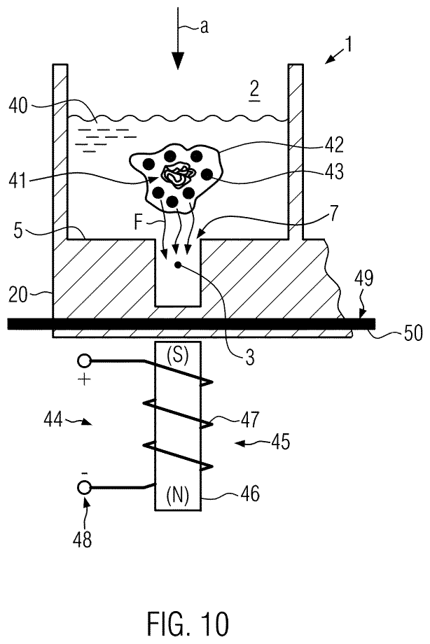

FIG. 10 a filled reaction vessel according to FIG. 1 in a reaction vessel unit and a magnetic device in a partially sectioned side view to illustrate a method according to an embodiment of the invention,

FIG. 11 is a sectional side view of a reaction vessel of a reaction vessel unit according to an embodiment of the invention;

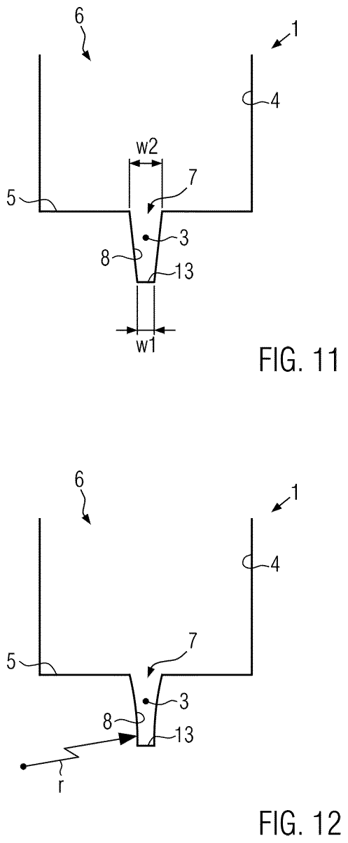

FIG. 12 is a sectional side view of a reaction vessel of a reaction vessel unit according to an embodiment of the invention;

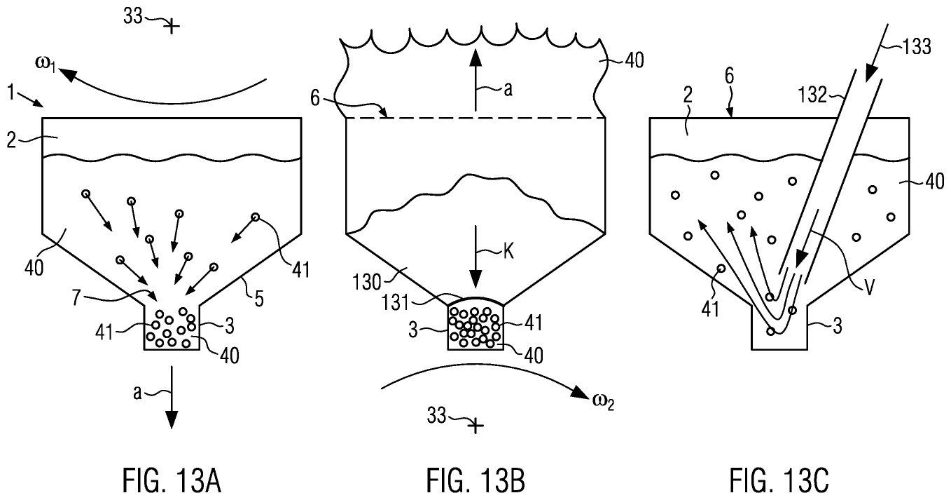

FIGS. 13A-13C a filled reaction vessel in a sectioned side view illustrating a method according to an embodiment of the invention;

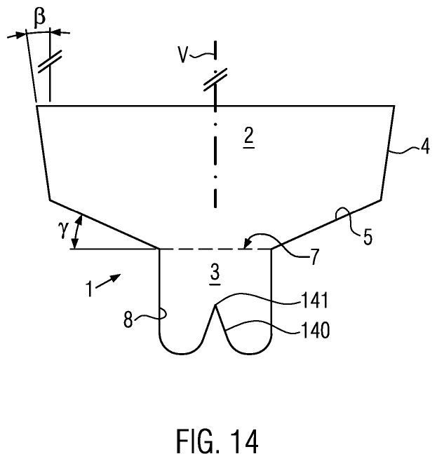

FIG. 14A sectional side view of a reaction vessel of a reaction vessel unit according to an embodiment of the invention.

All graphic representations are to be understood schematically. Size ratios may be distorted for clarification. Unless otherwise indicated, directional and positional designations refer to the customary use of the object of the invention. Unless otherwise indicated, the indication “horizontal” refers to a plane of openings 6 through which reaction vessels 1 of a reaction vessel unit 20 are to be filled or emptied, and the indication “vertical” refers to a direction at right angles to the horizontal.

A reaction vessel unit 20 has at least one reaction vessel 1 (FIGS. 1-7, 10). When used alone, the reaction vessel 1 can also be understood as a reaction vessel unit within the meaning of the invention. The reaction vessel 1 has a receiving chamber 2 for receiving a liquid and a capillary cavity 3 which opens into the receiving chamber 2. The receiving chamber 2 has a circumferential side wall 4 and a bottom wall 5. An upper edge of the side wall 4 can form an opening 6 of the receiving chamber 2. The capillary cavity 3 opens into the receiving chamber 2 via an opening 7 on the bottom wall 5. The capillary cavity 3 has walls 8 extending from the opening 7, which are so closely spaced that a liquid in the capillary cavity 3 is held in the capillary cavity 3 by capillary action.

The capillary effect occurs in narrow vessels and can be understood as a balance of forces between the surface tension of the liquid and an interfacial tension between the liquid and a vessel surface. In principle, a liquid can rise between narrow walls by capillary action and form a concave surface if the liquid wets the material of the wall, or descend and form a convex surface if the liquid does not wet the material of the wall. In addition to the surface tension and the contact angle, the capillary effect also depends on the density of the liquid, the radius or wall distance of the vessel and the gravitational acceleration. For example, the height of rise h of a column of liquid in a cylindrical vessel is described by the equation

$$h = \frac{2 σ cos θ}{ρ gr}$$

Where σ is the surface tension, θ is the contact angle, ρ is the density of the liquid, g is the gravitational acceleration and r is the radius of the vessel.

Since the capillary cavity 3 opens into the receiving chamber 2 and the walls 8 of the capillary cavity 3 are so closely spaced that a liquid is retained in the capillary cavity 3 by capillary action, a precisely defined residual volume can be retained in the capillary cavity 3 when the reaction vessel 1 is emptied, while the receiving chamber 2 is reliably emptied. Emptying can be performed, for example, by centrifuging, as described in more detail below, or by other means, such as aspiration/pipetting.

The bottom wall 5 of the receiving chamber 2 can be flat (FIG. 1). To facilitate emptying of the receiving chamber 2 as well as collection in the capillary cavity 3, the bottom wall 5 can also slope conically towards the opening 7 of the capillary cavity 3 (FIGS. 2, 13A-13C, 14) or be U-shaped (not shown in detail) to form a kind of funnel towards the capillary cavity 3. An inclination angle γ of the bottom wall 5 relative to the plane of the opening 7 of the capillary cavity 3 (this plane is perpendicular to the vertical V and thus a horizontal plane) must be adapted to the application; it can advantageously be between 5° and 75°. An edge 9 between the bottom wall 5 and the side wall 4 of the receiving chamber 2 can be sharp or rounded, wherein rounded edges can facilitate emptying of the receiving chamber 2. In the illustrated embodiment example, the side wall 4 of the receiving chamber 2 forms a square cross-section (FIGS. 3, 4, 5, 7), thus having in particular several side walls 16 which meet at edges 17 and form the overall closed side wall 4 (see FIG. 3). However, this is not a limitation of the invention. In variations, the cross-section of the receiving chamber 2 can also be rectangular or generally polygonal, for example diamond-shaped or hexagonal, or round, oval, elliptical or curved in any desired manner. The edges 17 between the individual side walls 16 can be sharp or rounded, wherein rounded edges 17 can facilitate emptying of the receiving chamber 2.

The capillary cavity 3 can be round (FIG. 3) or square (FIG. 4) or oval (FIG. 7) in cross-section or have any other suitable cross-sectional shape. The opening 7 of the capillary cavity 3 can be arranged in the centre of the bottom wall 5, as is the case in the embodiments shown in FIGS. 1 to 8. In variations, the opening 7 of the capillary cavity 3 can also be arranged off-centre in the bottom wall 5 of the receiving chamber 2.

An edge 10 (see FIGS. 1, 2) between the walls 8 of the capillary cavity 3 and the bottom wall 5 of the receiving chamber 2 can be sharp or rounded. In this case, a sharp edge 10 can facilitate retention of the liquid in the capillary cavity 3 by capillary action.

The capillary effect is determined by the wall distance between opposite side walls 18 or wall sections 19 of the wall 8 of the capillary cavity 3, wherein the surface properties and the surface tension of the liquid also have a considerable influence on the capillary effect. The wall distance between opposing side walls 18 or wall sections 19 of the capillary cavity 3 is thus dimensioned such that liquid is held by capillary action between the opposing side walls 18 or wall sections 19 of the capillary cavity 3. Depending on the liquid and the nature of the wall 8 of the capillary cavity 3, the wall distance can be roughly between 0.1 mm and 2.0 mm, for example. Suitable upper limits and lower limits were mentioned above, wherein the specifically selected upper limit will be determined by the expected or desired capillary effect and the specifically selected lower limit will be determined by the application. The ratio of the wall distance of the capillary cavity 3 to the wall distance of the receiving chamber 2 itself is also decisive for the application. If the capillary cavity 3 is too wide in relation to the receiving chamber, it can be difficult to realise a technically usable difference in the capillary effect. The capillary effect of the capillary cavity 3 must therefore always be understood in relation to a capillary effect in the receiving chamber 2 that is conceivable in principle, but then significantly smaller. The capillary effect of the receiving chamber 2 can also be further reduced by widening the side wall 4 of the receiving chamber 2 towards the opening 6 by an opening angle β relative to the vertical V (FIG. 14). The opening angle β can be between 0.5° and 5°, for example, in order to significantly reduce the capillary effect.

In one embodiment example, the capillary cavity 3 is formed from two opposing side walls 18, the distance between which is dimensioned to exert the capillary effect, and a bottom wall 12 extending between the side walls 18, wherein the bottom wall 12 is curved and ends in the edge 11 at the opening 7 in the bottom wall 5 of the receiving chamber 2 (FIGS. 5, 6A). In cross-section, the bottom wall forms a smooth continuous arc (FIG. 6A).

Thus, the capillary cavity 3 in this embodiment example has an elongated cross-sectional shape, in particular at the opening 7. Sometimes it may be desirable to first empty the receiving chamber 2 and then also remove the residual volume remaining in the capillary cavity 3. In this embodiment example, this is particularly easy by flushing out the fluid volume held in the capillary cavity 3 by capillary action using a jet of liquid or compressed air along the curved bottom wall 12. In a modified embodiment example, the capillary cavity 3 can have the two opposing side walls 18, the distance between which is dimensioned to exert the capillary effect, and a flat bottom wall 13 extending between the side walls 18 as well as two end walls 14 extending obliquely from the flat bottom wall 13 at an edge 15 and extending between the side walls 18, wherein the oblique end walls 14 end in the edge 11 at the opening 7 in the bottom wall 5 of the receiving chamber 2 (FIGS. 5, 6B). The effect of facilitated emptying of the capillary cavity 3 corresponds to the variant with curved bottom wall 12, wherein the effect is all the more pronounced the more flat-angled the end walls 14 are.

If the reaction vessel 1 is emptied by centrifuging, the orientation of the capillary cavity 3 to the direction of rotation determines whether the residual volume is retained in the capillary cavity 3 or is also centrifuged out. If the side walls 18 of the capillary cavity 3 are aligned at right angles to the direction of rotation, the residual volume is retained in the capillary cavity 3. When the side walls 18 of the capillary cavity 3 are aligned with the direction of rotation, the residual volume is ejected from the capillary cavity 3. Therefore, the reaction vessel unit is preferably designed such that the side walls 18 of the capillary cavity are aligned transversely to the direction of rotation during Centrifuging.

In a variation, a capillary cavity can also be formed by a structure located anywhere in the receiving chamber that protrudes from the bottom or side walls. Such a capillary cavity can be realised, for example, by a ring structure with a narrow diameter or by parallel walls that form a capillary gap.

This can be used, for example, to advantageously form a release system, i.e. a system for the time-delayed release of a target substance into a liquid in the receiving chamber. The capillary cavity is filled as described above and the receiving chamber is then filled with another liquid. Instead of mixing immediately with the liquid, the target substance can slowly pass into the liquid, for example by diffusion. One application is, for example, a series of tests on the long-term effect of a drug on a cell culture. The target substance in the capillary cavity is the drug or reagent that is to interact with the cells and whose effect on cell growth, for example, is being tested. A nutrient solution with the cell culture fills the receiving chamber. The cells can also be adherent, i.e. they adhere to the surface of the receiving chamber. Alternatively, the cells can also be held in a second capillary cavity. During the experiment, the reagent should be brought into contact with the cells. Depending on the design of the capillary, this release system can release the reagent immediately or over a longer period of time. The release system and the release of the reagent can be controlled by exerting a centrifugal force. For this purpose, it is advantageous if the capillary cavity with the reagent is open at the top (on the outside in the radial direction), such as two vertical ribs in a side wall. If the cells are held in a second capillary cavity, it is advantageous if the holding effect there is greater than in the capillary cavity with the reagent. In order to prevent the nutrient liquid from escaping from the receiving chamber during centrifugation, a lid can be provided which closes the receiving chamber tightly, at least for this time.

To improve the capillary effect when handling aqueous liquids, the capillary cavity 3 can have a hydrophilic coating. To facilitate emptying of the receiving chamber 2, the receiving chamber can have a hydrophobic coating. This can be achieved by using PTFE, for example, or generally by using substances that have contact angles of approximately 90° or greater in the presence of water.

FIG. 11 shows a modification of a reaction vessel 1 in which the walls 8 of the capillary cavity 3 have a widening towards the opening 7. In other words, the walls 8 have a distance d2 in the region of the opening 7 which is greater than a distance d1 in the region of the bottom wall 13. The widening enables the volume removed from the capillary cavity 3 to be controlled via the centrifugal force during Centrifuging, since a balance of forces between centrifugal force and holding force depends on the distance between the walls and the angle of spread between the walls. Preferably, the capillary cavity is designed so that it expands gradually or approximately evenly from the bottom wall 13 to the opening 7, so that the horizontal cross-sectional area of the capillary cavity 3 becomes increasingly larger in the direction of the opening 7. This allows the capillary cavity to be emptied to varying degrees using different centrifugal forces.

A similar effect can be achieved if the walls of the capillary cavity have a coating with a decreasing hydrophilic or lipophilic effect towards the opening of the capillary cavity. In a variant of the above-mentioned modification, the walls 8 can be curved in order to realise the expansion (FIG. 12). A radius of curvature r of the wall 8 can be constant or variable in the course of the wall 8.

The capillary cavity 3 is an example of a retention area whose shape and/or surface properties are such that, due to an adhesive force between the liquid and the retention area and a cohesion within the liquid, the retention area exerts an increased retention effect on the liquid compared to the surrounding area, so that a predetermined small amount of liquid can be retained when the liquid is removed from the receiving chamber. It is also conceivable to create such a retention area on a bottom or side wall of the receiving chamber solely by an increased adhesive effect with the liquid in comparison with the surrounding area of the bottom or side wall, for example by different hydrophilic/hydrophobic or lipophilic/lipophobic formation, by different coating, roughening, smoothing, etc. It will be advantageous to design the size of such an area according to the desired residual volume so that, for example, a droplet of a defined size is formed which adheres to the area and remains as compact as possible without breaking up into several partial droplets.

It is also conceivable to provide several retention areas in one receiving chamber. The retention areas can be of the same design to accommodate several partial volumes of the same type, or of different types, for example to accommodate or hold partial volumes or target substances of different types. For example,

One embodiment of the invention is a reaction vessel unit 20 in the form of a microtiter plate with a frame 21 comprising a plurality of individual reaction vessels 1 (FIG. 8). The individual reaction vessels 1 of a microtiter plate 20 are also referred to as wells, which are usually arranged in a predetermined, regular grid of rows and columns. The grid specifies a staggered number of reaction vessels 1 and thus also determines the possible filling volume. Cells are cultivated individually or in cell clusters in such microtiter plates in connection with cell-based assays. As described at the beginning, the cellular structure should generally remain in the reaction vessel when the microtiter plates are washed, while the supernatant is removed and replaced with fresh medium, for example. This can be particularly well achieved with the reaction vessel unit according to the invention by providing a microtiter plate in which a capillary cavity is formed in the bottom of each well.

Microtiter plates are available in various sizes and designs. The base area usually corresponds to the ANSI standards recommended by the Society for Biomolecular Screening (SBS) of L=27.76 mm×W=85.48 mm×H=14.35 mm, wherein the height can vary. Common sizes are shown in the table below:

| Well | | Filling Volume |
|---|---|---|
| Quantity | Grid | (μl) |
| 6 | 2 × 3 | 2000 . . . 5000 |
| 12 | 3 × 4 | 2000 . . . 4000 |
| 24 | 4 × 6 | 500 . . . 3000 |
| 48 | 6 × 8 | 500 . . . 1500 |
| 96 | 8 × 12 | 100 . . . 300 |
| 384 | 16 × 24 | 30 . . . 100 |
| 1536 | 32 × 48 | 5 . . . 15 |
| 3456 | 48 × 72 | 1 . . . 5 |

The name of a microtiter plate depends on the number of wells. For example, a microtiter plate with 24 wells is called a 24-well microtiter plate, a microtiter plate with 384 wells is called a 384-well microtiter plate and so on. The wells can have different bottom shapes, such as F-bottom (flat bottom), C-bottom (flat bottom with minimally rounded edges), V-bottom (tapered bottom) and U-bottom (U-shaped well). The wells can have different cross-sectional shapes, such as round, oval, elliptical, square, diamond-shaped, hexagonal, wherein polygonal shapes can also have rounded edges.

In the illustrated embodiment example, the reaction vessel unit 20 is a 96-well microtiter plate with eight rows arranged in the direction of the width B and twelve columns arranged in the direction of the width B. A spacing of the reaction vessels 1 of x is the same in the length direction as in the width direction, but the invention is not limited to this. In the embodiment example shown, the reaction vessels 1 and their receiving chamber 2 are each of round cross-section, and the capillary cavities 3 embedded in the bottom wall of the receiving chamber 2 are also of round cross-section. However, the invention is not limited to this. To simplify the illustration, the reaction vessel unit 20 is only partially fully marked, while contours beyond a crack line are only dashed and reaction vessels 1 are only indicated by their centres.

The known centrifuges for washing microtiter plates are designed so that the rotation axis of the centrifuge is parallel to the longitudinal direction of the respective microtiter plate. It is therefore expedient that the elongated capillary cavities explained above are also aligned parallel to the longitudinal direction of the microtiter plate.

Cells are grown in microtiter plates in connection with cell-based assays. The cells bind to the surface (they become adherent) and must sooner or later be subjected to a media change, as the culture medium will otherwise poison the cells or otherwise render them unusable. Inventive methods exist that enable centrifuge-based washing of microtiter plates, such as those described in US 2021/138485 A1 and U.S. Pat. No. 11,117,142 B2 mentioned above. Recently, cell assemblies have been increasingly used in the pharmaceutical industry for testing purposes. These are spheroids or organoids, i.e. cells in clusters (up to several hundred). These are also grown in microtiter plates, wherein their smooth surface often prevents the cells from adhering. This means that the spheroids and organoids float freely in solution. In order to carry out media changes, it is desirable to fix the cell clusters so that media can be changed without losing the cells. Various matrices can be used for this purpose, which are poured into the plate so that the cells are trapped and can grow. One example is the matrix GrowDex (www.Growdex.com). One third of a well is filled with matrix and two thirds with culture medium. The matrices have approximately gel-like properties and stick to the plate, but not very firmly. In centrifuge-based washing, one would only wish to wash the medium out of the plate without washing out the cells (including the matrix). However, above a certain centrifugal acceleration, the gel would also be thrown out of the plate.

The present invention is very well applicable to such a reaction vessel unit 20 in the form of a microtiter plate which is washed by means of a centrifuge. For a given system of capillary cavity 3 and liquid, a limit value can be determined for an acceleration acting away from the opening 7 of the capillary cavity 3, below which the capillary effect predominates. If the microtiter plate is to be emptied as reaction vessel unit 20 while retaining the residual volume in the capillary cavity 3, the speed of the centrifuge can be set to a value that is safely below the limit value. The capillary cavity 3 of the reaction vessel 3 1 has an equally advantageous effect if the reaction vessel 1 is emptied by other means, such as by means of a pipetting device.

Prototypes have shown that the limiting speed for aqueous solutions with uncoated polycarbonate microtiter plates is typically in the range of a few 100 rpm and preferably not greater than 1000 rpm and in particular not greater than 800 rpm or 500 rpm or 300 rpm.

Microtiter plates, as well as other types of reaction vessel units or reaction vessels, can advantageously be made of plastic and can be manufactured using the well-known manufacturing processes, such as injection moulding or the like. In particular, the reaction vessel unit 20 in the form of the microtiter plate can be formed integrally with all reaction vessels 3. However, the invention is neither limited to the choice of material nor to the one-piece design.

A method for selectively removing a liquid from the reaction vessel 1 of a reaction vessel unit 20 using a centrifuge 30 is another embodiment of the invention (FIG. 9).

The centrifuge 30 is shown only with the parts that are essential for understanding the invention. The centrifuge 30 has a frame-shaped rotor 31 which is fixed in rotation on a shaft 32. The shaft 32 can be set in rotation by a motor (not shown in detail) in order to rotate at an angular speed w or a corresponding rotational speed n about a centrifuging axis 33, which can be controlled and regulated by a control unit (not shown in detail), wherein the rotor 31 also rotates. A cover 34, which may be in the form of a cylindrical tube and may be part of a housing not shown in detail, surrounds the frame 31. A carrier 35 for receiving a reaction vessel unit 20 is arranged in a receiving section of the rotor 31. In particular, the carrier 35 together with a reaction vessel unit 20 in the form of a microtiter plate can be pushed by a loading unit (not shown in detail) from the end face of the rotor 31 into its receiving section, wherein the receiving section can receive the carrier 35 in the manner of a rail and hold the reaction vessel unit 20 in the manner of a clamp radially from the outside.

To apply the method, the liquid is first contained in a reaction vessel 1 of the reaction vessel unit 20 as described above. The reaction vessel unit 20 is then placed on the carrier 35 and loaded into the centrifuge 30, wherein the mouth 6 of the receiving chamber 2 of the reaction vessel 1 faces away from the centrifugation axis 33 (upper part (A) in FIG. 9). Finally, the rotor 31 is set in rotation with the reaction vessel unit 1, wherein the speed n is controlled such that it is less than a limit speed at which the capillary effect of the capillary cavity 3 is just overcome. In this way, it is possible to ensure that the liquid in the capillary cavity 3 remains therein and the remaining liquid in the receiving chamber 2 is centrifuged out, i.e. removed. For this purpose, the centrifuge 30 can be controlled with a suitable time-speed profile. The centrifuged liquid can be collected in the interior of the cover 34 and discharged. It can also be trapped in a catcher plate or other collecting device, which is placed with at least one of its openings on the reaction vessel unit 20 before centrifugation in order to be able to reuse the centrifuged liquid. The carrier 35 with the washed reaction vessel unit 20 can be removed and the reaction vessel unit 20 with the residual volume retained in the capillary cavity 3 can be reused. For example, if a target substance such as a cell arrangement in a matrix has been received in the capillary cavity 3 and used nutrient liquid has been removed from the receiving chamber 2 by the method described, the receiving chamber 2 can be filled with new nutrient liquid and the cells can be further grown.

Of course, the process is also suitable for separating any volume of liquid.

A method for introducing a liquid 40 containing a target substance 41 into a reaction vessel 1 of a reaction vessel unit 20 is another embodiment of the invention, which can also be carried out with the aid of the centrifuging device 30 (FIG. 9).

To carry out the method, the reaction vessel unit 20 is first used to hold the liquid 40 together with the target substance 41 in one of the reaction vessels 1 (FIG. 10). The target substance 41 may or may not be embedded in a matrix 42. An auxiliary substance 43 can, but does not have to, also be embedded in the matrix 42. The reaction vessel unit 20 is then placed on the trough 35 and loaded into the centrifuge 30, wherein the opening 7 of the capillary cavity 3 of the reaction vessel 1 points radially to the centrifugation axis 33 (lower part (B) in FIG. 9). The rotor 31 with the reaction vessel unit 1 is then set in rotation, wherein a centrifugal acceleration a acts in the direction of the bottom wall 5 of the receiving chamber 2, which separates the target substance 41, possibly together with matrix 42 and optional auxiliary substance 43, from the rest of the liquid 40 and forces it into the capillary cavity 3 of the reaction vessel 1. In this case, the speed n of the centrifuging device 30 can be controlled so that it is greater than a second limit speed at which a resistance that may result from a volume of air or liquid present in the capillary cavity 3 can be reliably forced out of the capillary cavity 3. For this purpose, the centrifuging device 30 can be controlled with a suitable time-speed profile. The trough 35 with the reaction vessel unit 20 can then be removed and the reaction vessel unit 20 with the target substance 41 held in the capillary cavity 3 can continue to be used. For example, if a target substance 41 such as a cell arrangement in the matrix 42 is accommodated in the capillary cavity 3 and the remaining liquid 40 is nutrient liquid, the reaction vessel 1 or the reaction vessel unit 20 can be used to attract the cells. Until the reaction vessels 1 are completely emptied, nutrient liquid can always be removed as required using the method described above and replaced with new nutrient liquid, wherein the target substance 41 remains reliably in the capillary cavity 3.

Together with the arrangement of the reaction vessel unit 1 with the opening 7 of the capillary cavity 3 pointing radially to the centrifugation axis 33, the centrifuge 30 forms a guidance system within the meaning of the invention, which is designed to move the target substance in a desired direction.

A further method for introducing a liquid 40 containing a target substance 41 into a reaction vessel 1 of a reaction vessel unit 20 is a modification of the previous embodiment of the invention, which differs from it in the guidance system used. This modification uses an auxiliary material 43, which is magnetic, and a magnetic device 44, which is arranged to interact with the magnetic auxiliary material 43 in order to carry out the process (FIG. 10).

Again, a liquid 40 with a target substance 41 can be filled into the reaction vessel 1 of a reaction vessel unit 20 and received therein. The target material 41 may be, for example, a cellular structure such as a spheroid or an organoid, but the invention is not limited thereto. The auxiliary material 43 may comprise, for example, magnetic beads. The magnetic device 44 may comprise an electromagnet 45 comprising a ferrite core 46 and a winding 47, and a current source 48. To carry out the method, the electromagnet 45 may be arranged precisely below the capillary cavity 3 of the reaction vessel 1. In practice, the magnet device 44 can also be stationary and the reaction vessel 1 can be positioned relative to the magnet device 44 such that the capillary cavity 3 of the reaction vessel 1 comes to lie exactly above the electromagnet 45. In particular, if the reaction vessel 1 is part of a reaction vessel unit 20 such as a microtiter plate, the magnetic device may have a plurality of electromagnets 45 which are arranged exactly in the grid wells of the microtiter plate. When the power source 48 is switched on, the ferrite core 46 is polarised and can exert a magnetic attraction on the magnetic auxiliary material 43. The latter is thus pushed into the capillary cavity 3 and pulls the matrix 42 along with the target material 41. One or more permanent magnets can also be used instead of one or more electromagnets.

Instead of the magnetic auxiliary material 43, a magnetic property of the target material 41 or the matrix 42 itself can also be utilised in order to interact with the magnetic device 44. For example, the target material 41 could comprise ferritic material or biomagnetically active cells. Since biomagnetic phenomena are often very weak, it may be necessary to design the magnetic device 44 accordingly in order to achieve the required interaction.

A further modification of the method for introducing a liquid containing a target substance into a reaction vessel 1 of a reaction vessel unit 20 differs again in the control system used. This modification uses an auxiliary material 43, which is electrostatically charged, and an electrode device 49, which is arranged to interact with the auxiliary material 43 in order to carry out the method (FIG. 10).

Again, a liquid 40 with a target substance 41 can be filled into the reaction vessels 1 of a reaction vessel unit 20 and received therein. The target substance 41 may be, for example, a cellular structure such as a spheroid or an organoid, but the invention is not limited to this. The auxiliary material 43 may comprise, for example, ionised particles. The electrode device 49 may comprise an electrode 50 extending below the capillary cavity 3 of the reaction vessel 1 and a current source (not shown in detail). The electrode 50 may be integrated in the bottom of the reaction vessel 1 or that of the reaction vessel unit 20 or provided externally, wherein in the latter case the electrode 50 must be arranged under the capillary cavity 3 of the reaction vessel 1 in order to carry out the process. When the power source is switched on, the electrode 50 exerts an attractive force on the electrostatically charged auxiliary material 43. This forces it into the capillary cavity 3 and pulls the matrix 42 along with the target material 41.

The electrode can have a flat expansion in the area of the capillary cavity 3, while it is thin in areas away from the capillary cavity 3, so that the electrostatic attraction is concentrated under the capillary cavity 3. In particular, if the reaction vessel 1 is part of a reaction vessel unit 20, such as a microtiter plate, the electrode 50 can have a grid-like design, wherein grid nodes are arranged exactly in the grid of the wells of the microtiter plate and may have the planar expansion described above.

Instead of the electrostatically charged auxiliary material 43, an electrostatic property of the target material 41 or the matrix 42 itself can also be utilised in order to interact with the electrode device 49. For example, the target material 41 could have charged cells or molecules. Since such charges are often very weak, a corresponding design of the electrode device 49 may be necessary to achieve the required interaction.

In this embodiment example with all its modifications, after the successful introduction of the target substance, the supernatant, i.e. the residual volume not received in the capillary cavity, can be removed from the receiving chamber 2 using the method described above for separation or selective removal. Here, too, a collecting device can be advantageously used to collect the residual volumes, for example in order to be able to reuse expensive reactants or utilise them elsewhere.

Other applications are also conceivable for the basic selective removal process:

If, for example, different g-forces act during centrifugation (this is particularly the case with a small radius, as reaction vessels that are radially further out are accelerated more strongly), then it is possible to empty differentially or to introduce a target substance differentially into the reaction vessels of a reaction vessel unit. It is also possible to imagine a titration series along a gradient of g-forces.

Conversely, a reaction vessel unit is conceivable in which the forces occur due to different adhesion or capillary action in such a way that the physically existing gradient in the centrifugal acceleration (due to the different radius) is precisely balanced by means of suitable formation of the retention areas and the retained partial volumes have the same size everywhere after centrifugation despite this gradient.

The principle of the invention can also be used to form a system for the controlled and time-delayed release of a target substance to a sample, a so-called release system. In a modification, a capillary space can also be formed by a structure located somewhere in the receiving chamber which protrudes from the bottom or side walls and forms a capillary gap.

This can be used to do the following: a capillary located somewhere in the plate is filled as described here. A reagent is a substance that is intended to interact with cells and whose effect on cell growth, for example, is tested. In a cell experiment, the reagent is usually brought into contact with the cells in the receiving chamber. The cells can also be adherent, i.e. they adhere to the surface of the receiving chamber. Depending on the design of the capillary, this release system can release the reagent immediately or over a longer period of time. The release system and the release of the reagent can be controlled by exerting a centrifugal force.

A particularly advantageous application of the invention is a method for purifying cells which form a target substance 41. The target substance 41 can also equally comprise cell clusters, cell aggregates or organisms or other, in particular organic/biological substances, but only cells are mentioned below by way of example. The cells are located in a reaction vessel 1 of a reaction vessel unit in suspension in a liquid 40. The reaction vessel 1 has a funnel-shaped bottom wall 5, which opens into a capillary cavity 3. In a specific example, the reaction vessel unit can be designed in a 96-microtiter plate format, for example. The reaction vessels 1 can have a receiving chamber 2 with a working volume of 200 μl and a capillary cavity 3 with a volume of 5 μl. The cells are initially distributed largely uniformly in the receiving chamber 2 of the reaction vessel unit 1; the capillary cavity may also contain cells whose distribution essentially corresponds to the distribution in the remaining receiving chamber 2.

At predetermined intervals or to carry out a test on cells in suspension, it is necessary to replace the liquid 40 with fresh liquid 40 or another liquid 40 without removing the cells from the reaction vessel 1. This exchange is referred to as purification.

In the present method, in a first step, the reaction vessel unit is picked up in a centrifuge in such a way that the capillary cavity 3 faces away from the centrifugation axis 33 (see arrangement (B) in FIG. 9), and is caused to rotate about a centrifugation axis 33 at an angular velocity w1. This exerts an acceleration a on the suspension, causing the cells to gather in the capillary cavity 3, supported by the slope of the funnel-shaped bottom wall 5 (FIG. 13A). In this example, the angular velocity w1 is set so that the acceleration a is 10 to 30 g and the centrifugation takes 2 to 4 minutes. At the end of this step, there are no or hardly any cells left in the receiving chamber 2 above the capillary cavity 3.

In a second step, the reaction vessel unit is picked up in the same or another centrifuge in such a way that the capillary cavity 3 faces the centrifugation axis 33 (see arrangement (A) in FIG. 9), and rotated about the centrifugation axis 33 at an angular velocity w2. The angular velocity w2 is set in such a way that the liquid 40 is ejected from the receiving chamber 2 of the reaction vessel 1 under the effect of the acceleration a, while the cells in the capillary cavity 3, which are still in suspension but at a much higher concentration, are held in the capillary cavity 3 by capillary forces K. The liquid 40 in the receiving chamber 2 separates from the liquid 40 with the cells in the capillary cavity 3, atmosphere 130 flows into the space above the capillary cavity 3 so that a phase boundary 131 is formed which spans the opening 7 of the capillary cavity 3 and whose surface tension contributes to the capillary effect (FIG. 13B). At the end of this step, the receiving chamber 2 above the capillary cavity 3 is completely emptied of liquid 40 and the cells are concentrated in the capillary cavity. The emptying process can take about 30 seconds in this example.

In a third step, the receiving chamber 2 of the reaction vessel 1 is refilled with liquid 40. In the present embodiment example, this is done by a dispensing device. The liquid 40 is dispensed into a dispensing nozzle 132 into the receiving chamber 2. A liquid flow 133 has a velocity v at the outlet of the dispensing nozzle 132. In the present method, the dispensing nozzle 133 is directed towards the capillary cavity 3 so that the cells (41) are flushed or rinsed out of the capillary cavity 3 and distributed in the liquid 40 throughout the receiving chamber 2 (FIG. 13C). The speed is such that, although the cells are flushed out of the capillary cavity 3, they always remain in suspension in the liquid 40 without the liquid 40 sloshing out of the reaction vessel 1. Although shown as such in the figure, it is not necessary for the dispensing nozzle 132 to protrude into the receiving chamber 2. Rather, the dispensing nozzle 132 can also end above the opening 6 of the receiving chamber 2. At the end of this step, the cells are again largely evenly distributed in the liquid 40 in the receiving chamber 2. In the present example, the filling process can take about 15 seconds (preferably for all ninety-six reaction vessels 1 in this example, which are filled row by row in particular).

With this process, the stress on the cells during purification can be significantly reduced compared to conventional processes, such as pelletisation. A loss of cells, which can occur during emptying in the second step, can be kept to a minimum (less than 10%) and can be replaced before, after or during refilling if necessary.

The dispensing device may be attached to the centrifuge, and the reaction vessel unit may be moved by a loading and unloading device of the centrifuge, enabling accurate and efficient positioning of the reaction vessel unit with respect to a rotational space of the centrifuge and with respect to the dispensing device. The reaction vessel unit can remain on or in the centrifuge during the entire process. A centrifuge with a loading and unloading device comprising a rigid displacement rod for positioning the reaction vessel unit in or for removing the reaction vessel unit from a rotor of the centrifuge, wherein the displacement rod is arranged to be displaceable by means of a linear motor in such a way that it moves in an unloading position, that it extends through the rotor in a discharge position in the rotor chamber and in a loading position is pulled out at least from the region of the rotor chamber which is occupied by the rotor during one revolution, is described in WO 2017/125598 A1, to the disclosure of which reference is made in full in this respect. A centrifuge equipped with such a loading and discharge device, in which a dispensing unit is also attached to an outer wall of the centrifuge, by means of which a reagent liquid can be fed to a reaction vessel unit located below it in the discharge position, is described in DE 10 2021 124 023.9, which has been published subsequently and to the disclosure content of which reference is made in full in this respect.

It will be understood that the collection of the cells in the capillary cavity 3 may be accomplished by means other than centrifuging, such as magnetically, electrostatically or the like, as previously described. Removal of the liquid 40 may also be performed by means other than centrifuging, such as pipetting. Refilling can also be carried out alternatively by pipetting.

The above purification process can be used advantageously in connection with test procedures in which cells are tested in suspension. A partial volume of the suspension in the purified state is removed for this purpose and fed to a test device. The loss of cells due to testing can optionally be replaced.

The capillary cavity 3 is essentially free of walls in order to avoid shading from dispensing jets, rinsing jets or the like, which could form dead zones in which a target substance remains undesirably during rinsing. To facilitate rinsing or pipetting, however, a central, for example pyramid-shaped or conical elevation 140 with a tip 141 can be provided at the bottom of the capillary cavity 3 (FIG. 14). The rest of the base of the capillary cavity 3 around the elevation 140 can be designed with as few edges as possible in order to enable the most laminar flow possible.

The invention can be briefly summarised as follows:

This application discloses a reaction vessel unit (20) having at least one reaction vessel (1) which has a receiving chamber (2) for receiving a liquid (40), wherein the receiving chamber (2) has a retention area which has such a surface texture and/or shape that due to an adhesive force between the liquid and the retention area and a cohesion within the liquid, the retention area exerts an increased retention effect on the liquid (40) with respect to the surrounding area, so that a predetermined small amount of liquid is retained at or in the retention area when the liquid (40) is removed from the receiving chamber (2) by centrifuging. Further disclosed is a method for selectively removing a liquid (40) from a reaction vessel (1) of the reaction vessel unit (20) by centrifugation. Further disclosed is a method for introducing a liquid (40) containing a target substance (41) into a reaction vessel (1) of the reaction vessel unit (20), wherein the target substance (41) is guided to the retention area by means of a guiding system by centrifugation or magnetic or electrostatic interaction. The application further discloses a method for purifying a target substance (41) distributed or suspended in a liquid (40), such as cells, cell clusters, cell aggregates or organisms, and a method for performing a test on a target substance (41) distributed or suspended in a liquid (40) using the reaction vessel unit (20) according to the invention.

1. A reaction vessel unit having at least one reaction vessel which has a receiving chamber for receiving a liquid, wherein the receiving chamber has a retention area which has such a surface texture and/or shape that due to an adhesive force between the liquid and the retention area and a cohesion within the liquid, the retention area exerts an increased retention effect on the liquid with respect to the surrounding area, so that a predetermined small amount of liquid is retained at or in the retention area when the liquid is removed from the receiving chamber by centrifuging.

2. The reaction vessel unit according to claim 1, wherein the receiving chamber is bounded by one or more circumferential side wall(s) and a bottom wall and the retention area is formed in or on the bottom wall of the receiving chamber.

3. The reaction vessel unit according to claim 1, wherein the retention area has a single capillary cavity which opens into the receiving chamber, wherein the walls of the capillary cavity are so closely spaced apart that a liquid is retained in the capillary cavity by capillary action.

4. The reaction vessel unit according to claim 3, wherein the capillary cavity is essentially free of dividing walls, so that a content of the capillary cavity can be completely removed from the capillary cavity by introducing a fluid jet.

5. The reaction vessel unit according to claim 3, wherein the capillary cavity has a rectangular, round or oval cross-section, wherein a wall distance (d) between opposite side walls or wall sections of the capillary cavity is dimensioned to hold liquid by capillary action between the opposite side walls or wall sections of the capillary cavity, wherein the wall distance (d) is preferably at most 2.0 mm or at most 1.8 mm or at most 1.6 mm or at most 1.4 mm or at most 1.2 mm or at most 1.0 mm or at most 0.8 mm, wherein the wall distance (d) is preferably at most 30% or at most 25% or at most 20% or at most 15% or at most 10% or at most 5% of a wall distance between side walls of the receiving chamber.

6. The reaction vessel unit according to claim 3, wherein the capillary cavity has a depth which is at least 0.5 times or at least 1 time or at least 1.5 times or at least 2 times a wall distance (d) between opposite side walls or wall sections of the capillary cavity.

7. The reaction vessel unit according to claim 3, wherein side walls of the capillary cavity are formed vertically or substantially vertically with a deviation of at most 5° or at most 3° or at most 2° or at most 1° or at most 0.5° from the vertical.

8. The reaction vessel unit according to claim 3, wherein a bottom wall of the receiving chamber slopes conically towards an opening of the capillary cavity or is U-shaped, wherein an angle of inclination (γ) of the bottom wall is at least 5° or at least 15° or at least 25° or at least 35° or at least 45° and/or at most 75° or at most 65° or at most 55° or at most 45°.

9. The reaction vessel unit according to claim 3, characterised in that wherein a side wall of the receiving chamber is formed to widen towards the mouth with a deviation of at least 2° or at least 3° or at least 5° or at least 10° from the vertical.

10. The reaction vessel unit according to claim 3, wherein the capillary cavity has two opposing side walls, the wall spacing (d) of which is dimensioned to exert the capillary effect, and a bottom wall extending between the side walls, wherein the bottom wall is continuously curved or wherein furthermore two end walls are provided which extend between the side walls and which rise from the bottom wall to an edge of the capillary cavity at an angle, in particular at a flat angle, or with a concave curvature.

11. The reaction vessel unit according to claim 3, wherein the walls of the capillary cavity have a widening and/or a coating with decreasing hydrophilic or lipophilic effect towards the opening of the capillary cavity, wherein an opening angle at the opening is preferably not more than 10° or not more than 5° or not more than 2° or not more than 1° or not more than 0.5°.

12. The reaction vessel unit according to claim 3, wherein the reaction vessel unit comprises a plurality of reaction vessels, wherein the capillary cavities are increasingly angled away from the centre of a line, which is in particular a centre line, which divides the reaction vessel unit or the arrangement of the reaction vessels into two halves, relative to a perpendicular on a plane in which the reaction vessels are arranged.

13. The reaction vessel unit according to claim 1, wherein the retention area has a surface structure increasing an adhesion effect on the liquid and a size such that a cohesion of the molecules is formed due to the cohesion within the liquid, that a predetermined amount of the liquid is held at or in the retention area.

14. The reaction vessel unit according to claim 1, wherein the retention area has a hydrophilic or lipophilic coating.

15. The reaction vessel unit according to claim 1, wherein that the receiving chamber is hydrophobically or lipophobically coated in the area surrounding the retention area, in particular complementary to the retention area.

16. The reaction vessel unit according to claim 1, wherein in that the reaction vessel unit is or comprises a microtiter plate in which a plurality of the reaction vessels is arranged in a predetermined grid.

17. The reaction vessel unit according to claim 16, wherein all reaction vessels have a mouth on an upper side of the microtiter plate.

18. The reaction vessel unit according to claim 1, wherein the reaction vessel unit has a plurality of reaction vessels, wherein the retention effects of the retention areas of at least two reaction vessels are different, preferably such that the retention effect increases from a line, which is in particular a centre line, which divides the reaction vessel unit or the arrangement of the reaction vessels into two halves, so that a retention force of the retention area remains constant or approximately constant over the reaction vessels when the reaction vessel unit is rotated about an axis which is parallel to the centre line and whose radius extends through the centre line at right angles to a plane in which the reaction vessels are arranged.

19. The reaction vessel unit according to claim 1, wherein a collecting device is provided, which is arranged opposite an opening of the receiving chamber or openings of the receiving chambers of the at least one reaction vessel and is designed to catch liquid escaping or expelled from the receiving chamber or the receiving chambers.

20. The reaction vessel unit according to claim 19, wherein the collecting device has one or more compartments, preferably in the manner of a microtiter plate, wherein an opening of the compartment or openings of the compartments of the collecting device faces the opening of the receiving chamber or the openings of the receiving chamber of at least one of reaction vessels, wherein a number of the compartments of the collecting device is equal to, greater than or less than a number of the reaction vessels.

21. A method for selectively removing a liquid from a reaction vessel of a reaction vessel unit, including a receiving chamber for receiving a liquid, wherein the receiving chamber has a retention area which has such a surface texture and/or shape that due to an adhesive force between the liquid and the retention area and a cohesion within the liquid, the retention area exerts an increased retention effect on the liquid with respect to the surrounding area, so that a predetermined amount of liquid is retained at or in the retention area when the liquid is removed from the receiving chamber by centrifuging, the method comprising:
Centrifuging the reaction vessel unit with the opening of the receiving chamber pointing radially away from a centrifuging axis at a speed which is less than a limit speed at which the retaining effect of the retention area is just overcome, so that a partial volume of the liquid located in or at the retention area remains there and the remaining liquid located in the receiving chamber is removed.

22. The method according to claim 21, wherein the remaining liquid is collected in a collecting device.

23. A method for introducing a liquid containing a target material into a reaction vessel of a reaction vessel unit, comprising:
Using a reaction vessel unit which has a receiving chamber for receiving a liquid, wherein the receiving chamber has a retention area which has such a surface texture and/or shape that due to an adhesive force between the liquid and the retention area and a cohesion within the liquid, the retention area exerts an increased retention effect on the liquid with respect to the surrounding area, so that a predetermined small amount of liquid is retained at or in the retention area when the liquid is removed from the receiving chamber by centrifuging; and
Directing the target material to the retention area with a guiding system, wherein the guiding system comprises
a centrifuging device and an arrangement of the reaction vessel unit with the retention area lying radially outside or substantially outside with respect to a centrifuging axis in relation to the rest of the receiving chamber, or
a magnetic auxiliary material or a magnetic property of the target material and a magnetic device which is arranged to interact with the magnetic auxiliary material or the magnetic property of the target material, or
an electrostatically charged auxiliary material or an electrostatic property of the target material and an electrode device which is arranged to interact with the electrostatically charged auxiliary material or the electrostatic property of the target material.

24. The method according to claim 23, further comprising centrifuging the reaction vessel unit with the retention area located radially inwards or substantially inwards with respect to the centrifuging axis in relation to the rest of the receiving chamber at a speed which is less than a limit speed at which the holding effect of the retention area is just overcome, so that a partial volume of the liquid which is passed into or to the retention area and contains the target substance remains there and the remaining liquid located in the receiving chamber is removed.

25. The method according to claim 24, wherein the remaining liquid is collected in a collecting device, which is arranged opposite an opening of the receiving chamber or openings of the receiving chambers of the at least one reaction vessel and is designed to catch liquid escaping or expelled from the receiving chamber or the receiving chambers.

26. The method for purifying a target substance distributed or suspended in a liquid, such as cells, cell clusters, cell aggregates or organisms, in a reaction vessel of a reaction vessel unit, wherein the liquid is located in a reaction vessel unit having at least one reaction vessel which has a receiving chamber for receiving a liquid, wherein the receiving chamber has a retention area which has such a surface texture and/or shape that due to an adhesive force between the liquid and the retention area and a cohesion within the liquid, the retention area exerts an increased retention effect on the liquid with respect to the surrounding area, so that a predetermined small amount of liquid is retained at or in the retention area when the liquid is removed from the receiving chamber by centrifuging, the method comprising:
Collecting the target substance in the retention area, in particular by centrifuging with an arrangement of the reaction vessel unit such that the retention area is located radially outside or substantially outside with respect to a centrifuging axis in relation to the rest of the receiving chamber;
Removing the liquid from the receiving chamber by centrifuging the reaction vessel unit with the opening of the receiving chamber pointing radially away from a centrifuging axis at a speed which is less than a limit speed at which the holding effect of the retention area is just overcome, so that a partial volume of the liquid located in or at the retention area remains there and the remaining liquid located in the receiving chamber is removed;
introducing a further liquid into the receiving chamber, in particular by dispensing or pipetting; and
Mixing the target substance with the other liquid in the receiving chamber.

27. The method of claim 26, wherein the mixing comprises at least one of the following:
Leave standing for a predetermined time,
Shake the reaction vessel unit,
Introducing the further liquid into the receiving chamber by dispensing or pipetting in such a way that the target substance is washed off or washed out from the retention area,
Pipetting the target substance out of the retention area and pipetting it back into the introduced further liquid outside the retention area.

28. The method according to claim 26, wherein the receiving chamber has a volume of about 200 to 400 μl, wherein the retention area is a capillary cavity at the bottom of the receiving chamber and has a volume of about 5 μl, and wherein the collection of the target substance is carried out by centrifuging with at least 2 g or at least 5 g or at least 10 g or at least 20 g and/or at most 1000 g or at most 500 g or at most 200 g or at most 100 g or at most 50 g or at most 40 g or at most 30 g or at most 20 g for a time of at least 1 s or at least 2 s or at least 5 s or at least 10 s or at least 10 s or at least 30 s or at least 60 s or at least 90 s or at least 2 minutes or at least 5 minutes and/or for not more than 60 minutes or not more than 30 minutes or not more than 20 minutes or not more than 15 minutes or not more than 10 minutes or not more than 5 minutes or not more than 2 minutes or not more than 1 minute or not more than 30 s or not more than 20 s or not more than 10 s or not more than 5 s or not more than 2 s.

29. The method according to claim 26, wherein the remaining liquid is collected in a collecting device, which is in particular arranged opposite an opening of the receiving chamber or openings of the receiving chambers of the at least one reaction vessel and is designed to catch liquid escaping or expelled from the receiving chamber or the receiving chambers.

30. A method for carrying out a test on a target substance distributed or suspended in a liquid, such as cells, cell clusters, cell aggregates or organisms in a reaction vessel of a reaction vessel unit, wherein the liquid is located in a reaction vessel unit having at least one reaction vessel which has a receiving chamber for receiving a liquid, wherein the receiving chamber has a retention area which has such a surface texture and/or shape that due to an adhesive force between the liquid and the retention area and a cohesion within the liquid, the retention area exerts an increased retention effect on the liquid with respect to the surrounding area, so that a predetermined small amount of liquid is retained at or in the retention area when the liquid is removed from the receiving chamber by centrifuging, the method comprising:
purifying the target substance distributed or suspended in a liquid, such as cells, cell clusters, cell aggregates or organisms, in a reaction vessel of a reaction vessel unit, wherein the liquid is located in a reaction vessel unit having at least one reaction vessel which has a receiving chamber for receiving a liquid, wherein the receiving chamber has a retention area which has such a surface texture and/or shape that due to an adhesive force between the liquid and the retention area and a cohesion within the liquid, the retention area exerts an increased retention effect on the liquid with respect to the surrounding area, so that a predetermined small amount of liquid is retained at or in the retention area when the liquid is removed from the receiving chamber by centrifuging, comprising the steps of:
collecting the target substance in the retention area, in particular by centrifuging with an arrangement of the reaction vessel unit such that the retention area is located radially outside or substantially outside with respect to a centrifuging axis in relation to the rest of the receiving chamber;
removing the liquid from the receiving chamber by centrifuging the reaction vessel unit with the opening of the receiving chamber pointing radially away from a centrifuging axis at a speed which is less than a limit speed at which the holding effect of the retention area is just overcome, so that a partial volume of the liquid located in or at the retention area remains there and the remaining liquid located in the receiving chamber is removed;
introducing a further liquid into the receiving chamber, in particular by dispensing or pipetting;
mixing the target substance with the other liquid in the receiving chamber;
withdrawing a predetermined amount of the liquid in the reaction vessel with target substance dispersed or suspended therein; and
feeding the target substance contained in the predetermined amount to a test device such as a flow cytometry device.

31. A method for carrying out a test on a target substance distributed or suspended in a liquid, such as cells, cell clusters, cell aggregates or organisms in a reaction vessel of a reaction vessel unit, wherein the liquid is located in a reaction vessel unit, the method comprising:
Purifying the target substance according to the method of claim 27;
Withdrawing a predetermined amount of the liquid in the reaction vessel with target substance dispersed or suspended therein; and
Feeding the target substance contained in the predetermined amount to a test device such as a flow cytometry device.

32. A method according to claim 22, wherein the collecting device is arranged opposite an opening of the receiving chamber or openings of the receiving chambers of the at least one reaction vessel and is designed to catch liquid escaping or expelled from the receiving chamber or the receiving chambers, and the collecting device has preferably one or more compartments, preferably in the manner of a microtiter plate, wherein an opening of the compartment or openings of the compartments of the collecting device faces the opening of the receiving chamber or the openings of the receiving chamber of at least one of reaction vessels, wherein a number of the compartments of the collecting device is equal to, greater than or less than a number of the reaction vessels.
